(19) United States
(12) Patent Application Publication
(10) Pub. No.: US 2006/0141229 A1
(43) Pub. Date: Jun. 29, 2006

(54) Strand-shaped flexible profile, and method for its production

(75) Inventors: Bernd Pielsticker, Sarstedt (DE); Frank Reineke, Ronnenberg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: TROESTER GmbH & Co. KG, Hannover (DE)

(21) Appl. No.: 11/253,396

(22) Filed: Oct. 19, 2005

(30) Foreign Application Priority Data
Oct. 20, 2004 (DE) DE 102004051510.7
Oct. 21, 2004 (DE) DE 102004051511.5

(51) Int. Cl. B29C 47/06

(52) U.S. Cl. 428/212; 264/173.16; 264/172.11

(57) ABSTRACT

An extruded strand-shaped flexible profile includes a plurality of first elements including a first extrudable plastic having a first deformability, a first flexibility and a first hardness, and a plurality of second elements including a second extrudable plastic having a second deformability, a second flexibility and a second hardness. Each of the first and second elements are arranged alternatingly one after the other in a lengthwise direction of the strand. The first deformability is greater than the second deformability, the first flexibility is greater than the second flexibility, and the second hardness is greater than the first hardness. In addition, a method for producing a strand-shaped flexible profile includes extruding at a first extrudable plastic and a second extrudable plastic alternatingly one after the other in a lengthwise direction. The first extrudable plastic has a first deformability, a first flexibility and a first hardness, The second extrudable plastic has a second deformability, a second flexibility and a second hardness. The first deformability is greater than the second deformability, the first flexibility is greater than the second flexibility, and the second hardness is greater than the first hardness.

The invention relates to a strand-shaped flexible profile that is produced by an extrusion process using at least two different extrudable plastics as well as to a method for the production of such a profile.

It is a known procedure to produce strands out of two or more plastic extrudates in such a way that the plastic extrudates lie parallel to each other in the axial direction and they are joined at the contact surface to form a strand. Such strands are only flexibly pliable to the extent that the strand made of the less flexible plastic is pliable.

For the production of a flexible reinforced strand for a gasket to be installed in vehicles, European patent application EP 1 396 331 A1 discloses the technique of arranging two different plastic extrudates in the strand alternatingly one after the other, in other words, crosswise to the lengthwise direction of the strand as seen in this lengthwise direction. This flexible reinforced strand is embedded in the profile of the gasket and it supports the other plastic extrudate that forms the gasket. The flexibility of this strand determines the flexibility of the more flexible plastic. With this strand, the less flexible parts of the strand are used as the clamping elements that are arranged at intervals one after the other and that serve to fasten the strand.

British patent application GB 23 27 699 A describes a sealing strip having a fastening part that contains a yielding reinforcement means. European patent application EP 11 53 799 A1 also discloses a molded element consisting of two molded parts made of plastic.

Technical applications often require that strand-shaped objects be configured so as to be compression-proof and deformation-resistant but also so as to have the possibility that they can bend flexibly. These are properties that contradict each other. For this reason, compromises have to be accepted with such objects. If one wants to be able to lay a high-pressure tube, for example, in tight curves and also render it resistant to deformation caused by external forces, one has to install inserts and reinforcements in an effort to prevent a flexible plastic material from bursting when subjected to internal pressure or from being pinched when subjected to external pressure. This calls for a great deal of labor and material during production.

The invention avoids the drawbacks of the state of the art. It is the objective of the invention to configure strand-shaped objects to be made by plastic extrusion in a way that they are compression-proof and deformation-resistant and yet are also flexible. It is likewise the objective of the invention to create a method for the production of said objects.

The invention achieves the first cited objective in that the strand-shaped profile is made up of two different plastics arranged alternatingly one after the other in the lengthwise direction of the strand, one of which is a plastic with optimal deformability and flexibility while the other is a plastic that exhibits optimal hardness.

This is a strand that can be formed in a wide variety of ways and whose outer and inner shapes can be configured to serve all kinds of purposes. With such a strand, the deformable and non-deformable parts alternate with each other in the lengthwise direction of the strand. This profile strand is produced by an extrusion process in that two extruders feed into the shared head of these extruders that forms the profile of the strand and their extrudate is alternatingly fed one after the other to the mouthpiece of this extruder head, thereby creating a profile strand in which the flexible soft parts are each arranged between two inflexible hard parts.

This strand-shaped profile can be in the form of a strip, it can run in a straight line or else it can be laid in a curved shape immediately after being extruded, it can be in the form of a tube or also in the form of sheathing.

Thus, the profile can be in the form of sheathing for a strand-shaped or tubular object. The profile can be the sheathing of a tube that must not be pinched due to external pressure. The profile can sheath a high-pressure tube that then no longer needs to fulfill such high requirements in terms of its compressive strength since the compressive strength is largely provided by the hard parts of the sheathing. Moreover, the profile can be cable sheathing that protects a twisted bundle of conductors located in the center of the cable against radial shifting due to external pressure on the cable.

With this profile, the lengths of the plastic parts arranged one after the other in the strand can be the same or else they can be different. Longer firm parts will be employed when the profile strand is to be laid in large radii, whereas longer flexible parts will be used for laying in tighter radii.

The profile strand can have a web that extends to one side of the strand and that serves to clamp the profile strand in a groove. However, the profile strand can also have two webs that extend to one side of the profile and that serve for clamping the profile strand onto one edge of a projection.

The profile strand can also be designed in such a way that the side of the profile strand facing way from the web or webs is a support for another plastic layer or a veneer layer of the type employed, for example, in the furniture industry in order to create edges on furniture.

If the profile strand is to be attached to or onto an object, it can be advantageous for at least one side of the web in the area of the harder plastic elements to be provided with projections that serve as the clamping element.

The profile strand provided with one or more webs can be advantageously configured in such a way that the profile part onto which the webs are attached is hollow and has a rectangular or round cross section.

Among the wide variety of possible application possibilities, mention should still be made of the one in which electric conductors are accommodated in the profile part onto which the web or webs is/are attached.

The invention achieves the second cited objective by means of a method employing an extrusion process for the production of a strand-shaped flexible profile made up of two different extrudable plastics, whereby the strand-shaped profile is made of two different plastics that are arranged alternatingly one after the other in the lengthwise direction of the strand, one of which is a plastic with optimal deformability and flexibility while the other plastic exhibits optimal hardness. Here, the profile is especially extruded from an extrusion head with two extruders having a subsequent intermittent device in a continuous sequence one after the other.

The essence of the invention will be explained in greater detail below with reference to embodiments schematically depicted in the drawing. The following is shown:

FIG. 1—a cross section through a profile to be inserted into a groove, as a cover strip;

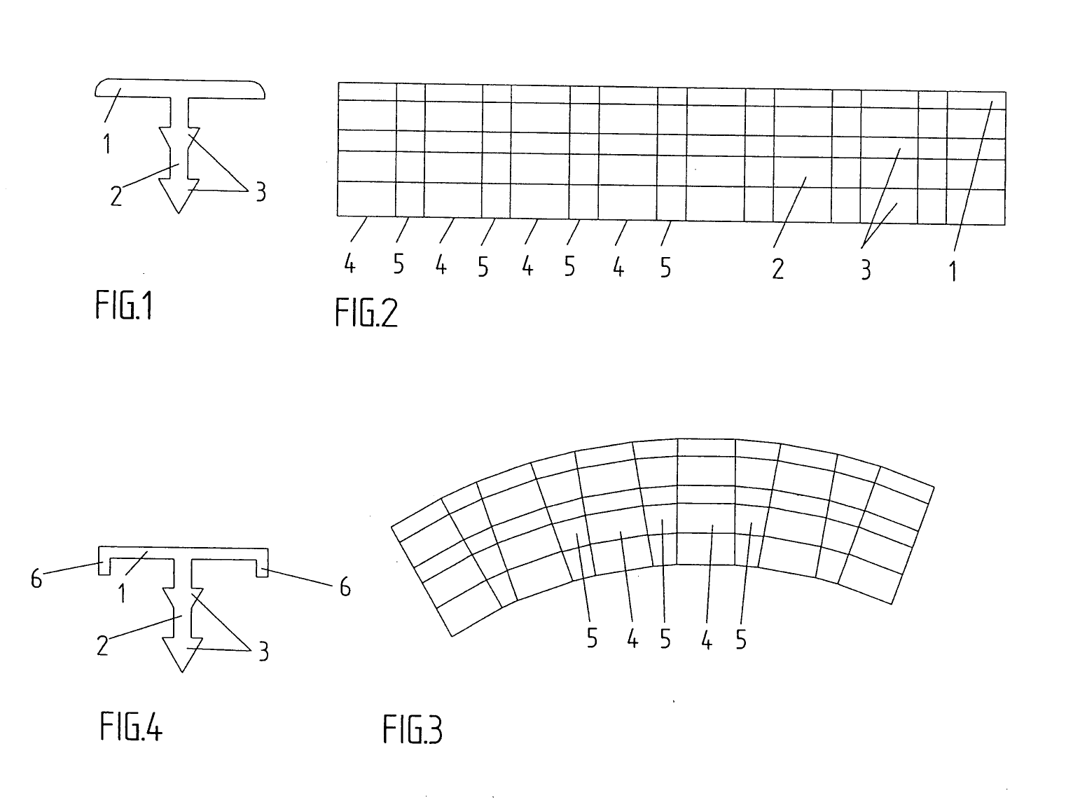

FIG. 2—a side view of this profile in a straight, drawn state;

FIG. 3—a side view of this profile in a curved state;

FIG. 4—a cross section through a profile whose cover strip is provided with flanges;

FIG. 5—a cross section through a profile in whose cover strip electric conductors are embedded;

FIG. 6—a cross section through a profile that has a hollow space in its cover strip;

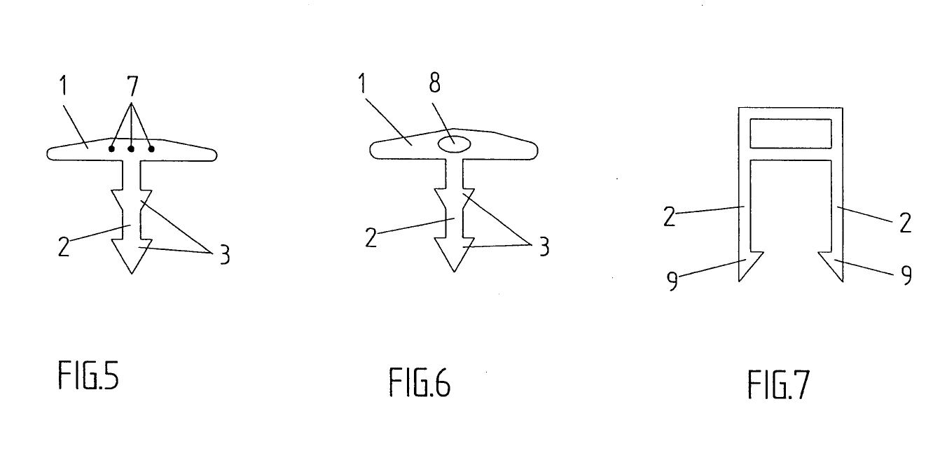

FIG. 7—a cross section through a profile that encloses one edge of an object by means of two ends provided with hooks;

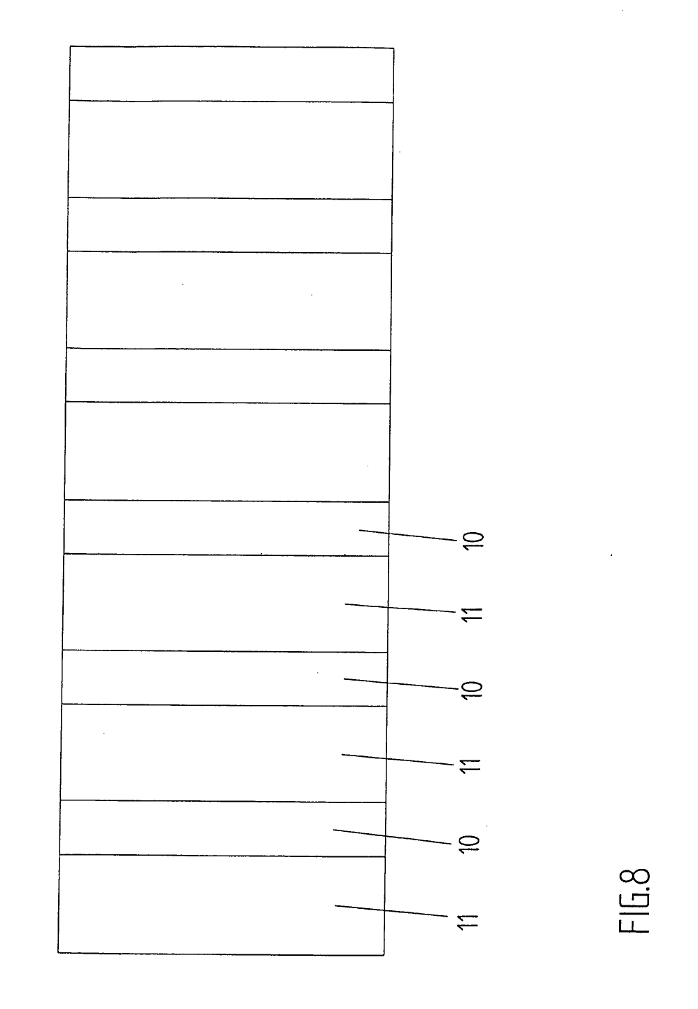

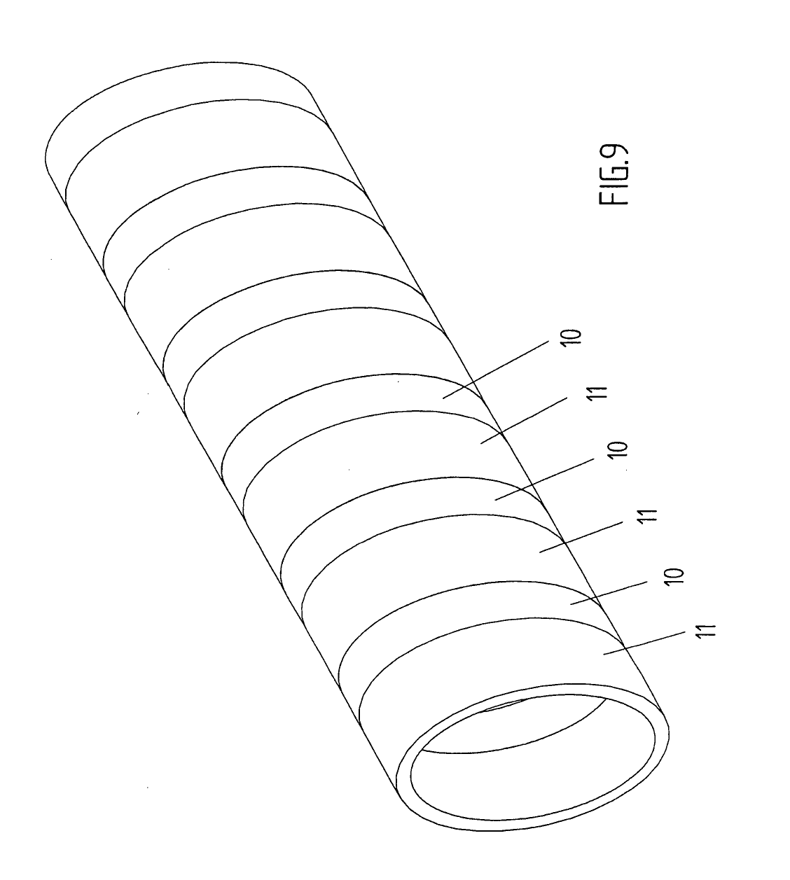

FIG. 8—a side view of a tubular profile;

FIG. 9—a perspective view of the tubular profile.

The cross section depicted in FIG. 1 through a cover strip that is to be inserted into a groove shows the actual cover strip 1 that has a web 2 on its back, said web being fitted with clamping elements 3. This profile consists of a plurality of elements 4 and 5 arranged one after the other and configured as plastic elements, one of which is an element 5 made of a plastic with optimal hardness while still having elastic deformability so that it exhibits optimal properties as a clamping element.

FIG. 2 shows a side view of this profile in the drawn state, as it is extruded from the extrusion head of two extruders having a subsequent intermittent device. The elements 4, 5 made of the two plastics are continuously extruded one after the other from this extrusion head.

FIG. 3 shows a side view of this profile in a curved state. It can be seen that the elements 4 made of hard plastic retain their form unchanged while the elements 5 made of soft plastic become deformed when the profile is bent.

FIG. 4 shows a cross section through another profile whose cover strip 1—which has the web 2 on its back, said web being fitted with clamping elements 3—is provided on both end edges of the cover strip 1 with flanges 6 that serve to grasp over the top and bottom surfaces of a panel.

FIG. 5 shows a cross section through a profile in whose cover strip 1 electric conductors 7 are embedded. Thus, this profile is at the same time a ribbon conductor in that the web 2 is fitted with the clamping elements 3.

FIG. 6 shows a cross section through a profile whose cover strip 1 has a hollow space 8 that can serve to subsequently pull in a cable or the like. This profile is likewise provided with a clamping function by means of the clamping elements 3 arranged on the web 2.

FIG. 7 shows a profile that can enclose an object by means of webs 2 onto whose ends hooks 9 facing each other are formed.

The tubular profile of FIGS. 8 and 9 consists of a plurality of rings made of two types of plastic, one of which is a type 10 made of a plastic that exhibits optimal flexibility and softness, while the other type 11 is made of another plastic that displays optimal hardness while still having elastic deformability. These two plastics are fed alternatingly one after the other to a shared extrusion head from which they are extruded as a continuous strand so that the strand thus generated consists of rings that are continuous on the fronts and that are arranged alternatingly one after the other in the lengthwise direction, and of these, the rings 10 provide the flexibility while the rings 11 provide the radial stability.

### LIST OF REFERENCE NUMERALS

1 cover strip
2 web
3 clamping element
4 element made of hard plastic
5 element made of soft plastic
6 flange
7 electric conductor
8 hollow space
9 hook
10 ring made of flexible plastic
11 ring made of hard plastic

1-24. (canceled)

25. An extruded strand-shaped flexible profile, comprising:
a plurality of first elements including a first extrudable plastic having a first deformability, a first flexibility and a first hardness; and
a plurality of second elements including a second extrudable plastic having a second deformability, a second flexibility and a second hardness, each of the first and second elements being arranged alternatingly one after the other in a lengthwise direction of the strand, wherein the first deformability is greater than the second deformability, the first flexibility is greater than the second flexibility, and the second hardness is greater than the first hardness.

26. The profile as recited in claim 25, wherein the profile is a clamp.

27. The profile as recited in claim 26, wherein the first deformability, the first flexibility, the second hardness are selected to for optimizing a clamping of the clamp.

28. The profile as recited in claim 25, wherein the profile forms a closed ring-shape along a circumference of the profile.

29. The profile as recited in claim 25, wherein the second deformability is elastic.

30. The profile as recited in claim 25, wherein the profile is in the form of a strip.

31. The profile as recited in claim 25, wherein the profile is in the form of a tube.

32. The profile as recited in claim 25, wherein the profile is in the form of sheathing and configured to sheath a strand-shaped object.

33. The profile as recited in claim 32, wherein the strand-shaped object is tubular.

34. The profile as recited in claim 33, wherein the strand-shaped object is a cable sheathing.

35. The profile as recited in claim 25, wherein the first plastic elements have a first length and the second plastic elements have a second length, the first and second lengths being the same.

36. The profile as recited in claim 35, wherein the first and second lengths are approximately 1 cm.

37. The profile as recited in claim 25, wherein the first plastic elements have a first length and the second plastic elements have a second length, the second length being greater than the first length.

38. The profile as recited in claim 25, wherein the profile has a main part and a web including the plurality of first and second elements and extending to a first side of the main part and is configured to clamp the profile in a groove.

39. The profile as recited in claim 25, wherein the profile has a main part and two webs including the plurality of first and second elements and extending to a first side of the main part, the two webs configured to clamp the profile onto an edge of a projection.

40. The profile as recited in claim 38, further comprising a layer supported on a second side of the main part facing way from the first side.

41. The profile as recited in claim 40, wherein the layer is plastic.

42. The profile as recited in claim 38, wherein at least one side of the web includes a plurality of projections configured as clamping elements, each projection being formed in an area of a respective second element.

43. The profile as recited in claim 39, wherein the main part is hollow and has one of a rectangular cross section and a round cross section.

44. The profile as recited in claim 42, wherein the projections are in the form of anchor-type barbs.

45. The profile as recited in claim 42, wherein the profile defines a longitudinal hollow space.

46. The profile as recited in claim 25, wherein the hollow space is configured to receive a strand-shaped object.

47. The profile as recited in claim 46, wherein the strand-shaped object is an electrical conductor.

48. The profile as recited in claim 39, wherein the main part includes a longitudinal hollow space configured to receive an electrical conductor.

49. A method for producing a strand-shaped flexible profile, the method comprising:
extruding at a first extrudable plastic and a second extrudable plastic alternatingly one after the other in a lengthwise direction, wherein the first extrudable plastic has a first deformability, a first flexibility and a first hardness, and the second extrudable plastic has a second deformability, a second flexibility and a second hardness, and wherein the first deformability is greater than the second deformability, the first flexibility is greater than the second flexibility, and the second hardness is greater than the first hardness.

50. The method as recited in claim 49, wherein the extruding is performed using an extrusion head, the extrusion head including two extruders and an intermittent device disposed downstream of the two extruders.

51. The method as recited in claim 49, wherein the extruding of the first and second plastics is performed in a continuous sequence one after the other.
